(19) United States
(12) Patent Application Publication
(10) Pub. No.: US 2007/0206566 A1
(43) Pub. Date: Sep. 6, 2007

(54) Adaptive phonebook database supporting communications between multiple users and devices

(76) Inventor: James D. Bennett, San Clemente, CA (US)

Correspondence Address: GARLICK HARRISON & MARKISON, P.O. BOX 160727, AUSTIN, TX, 78716-0727, US

(21) Appl. No.: 11/365,452

(22) Filed: Mar. 1, 2006

(51) Int. Cl. H04L 12/66

(52) U.S. Cl. 370/352

(57) ABSTRACT

A phonebook database, distributed across one or more of an initiating telephony device, recipient telephony devices, and one or more servers, supports a phonebook visual display for caller interaction. The database adapts based on changing status of recipients and recipient telephony devices, e.g., recent recipient activity, time of day or week information, device operational status, bandwidth and media capabilities, etc. The database also supports initiation of calls to recipients via for example handle-to-network address association. To maintain accurate phonebook content, multiple recipient devices and external support servers have access to the phonebook database either directly or indirectly (e.g., via another recipient device, server or recipient device). The database associatively stores client handle, network addressing, and meta-data information.

### TECHNICAL FIELD OF THE INVENTION

This invention relates generally to network based communications and more particularly to management of packet data communications between multiple client terminals.

### BACKGROUND OF THE INVENTION

Communication technologies currently allow Internet or network based voice communications. Internet voice communications allow users to make telephone calls using a computer network or other data network. Internet voice communications convert a voice signal into a digital packetized signal that travels over the network to the destination terminal. These Internet-based communications may be made through a personal computer (PC) attached to the Internet or other like network, or a traditional telephone having an adaptor that allows the traditional telephone to interface and place phone calls over the network. Additionally, some devices may facilitate communications within multiple networks. For example, a single device may serve as a traditional phone, cell phone, and/or Internet phone. Such devices are typically shared in the home by multiple family members.

One such Internet Protocol (IP) enabled service is known as Voice over Internet protocol (VoIP). VoIP allows voice communications to be packetized and exchanged using a broadband Internet connection instead of an analog or a traditional phone line. However, these Internet voice services currently allow users to call only other users that utilize the same service provider or to users available through the public switched telephone network (PSTN). This limitation may be imposed by incompatible CODECs chosen to packetize the voice communications, network addressing issues or other like difficulties. The requirement to use the same service provider in part arises from dynamic addresses. Such dynamic addresses make traditional phonebook entries stale and useless.

The Internet has also facilitated text messaging between two or more users, first with email, and now instant messaging (IM). Email communications do not require common service providers to be used by both the originating terminal and the destination terminal. An email address provides vectoring information to identify the communications intended destination and is made of several parts. The first part of the address is a username, identifier, or handle that identifies a unique user within a server. The ampersand (@) separates the username from the host name. The host name uniquely identifies the server computer network and is the second part of the email address. This host name may include a suffix that identifies the kind of organization operating the server such as .com, .edu, .gov, .mil, etc. This format for an email address identifies a location to which an email can be delivered. Since network based communications often require IP addresses for the destination terminal, and these addresses frequently change, Internet-based voice communications currently lack this addressing ability.

IM is a form of electronic communication which involves immediate correspondence between two or more users of a common IM service who are online simultaneously. To access such functionality, each user downloads and installs the same IM service provider's support software on their personal computing device. When in operation, the software attempts to maintain with a central server of that IM service provider the current IP address of the underlying user's personal computing device. If two users have such software in operation, either may initiate a correspondence to the other by retrieving the IP address of the other from the central server. However, IM, unlike email, requires both of the users to employ the same software and central server, i.e., the same IM service provider. Popular instant messaging services supporting at least textual correspondence include AOL's Instant Messenger (AIM), Microsoft MSN Messenger and Yahoo Messenger, for example. Some recent versions of IM also support voice communications (correspondence) between these users.

Instead of assigning permanent IP addresses to an individual user or computing device, Internet Service Providers (ISPs) often assign temporary IP addresses using, for example, a dynamic host configuration protocol (DHCP). Using the DHCP protocol, an ISP's DHCP server allocates and reallocates a pool of IP addresses as client devices log in and out. Upon logging in, each client device request the assignment of an IP address. The DHCP server responds by assigning a currently unused IP address from its pool. When a client device logs out or otherwise disconnects from the network, the DHCP server is free to reallocate the IP address to another client device. DHCP servers also maintain a database that associates each client device with its currently assigned IP address. With such dynamic address allocation, a client device may have a different IP address every time the device connects to the network. Additionally, DHCP servers may also support a mix of static and dynamic IP addresses.

The IP addresses of most client devices frequently change; using a current IP address to permanently and uniquely identify each client device is not always possible. Thus, when a user of one client device desires to contact another, a service provider can assist if both sign up for that service provider's maintenance and sharing of current IP addresses, i.e., if both users become members. More specifically, a typical IM or VoIP service provider maintains a database on a central server. The database associates each member's “name identifier” with the current IP addresses of that member's client device(s). To maintain an accurate database, each client device delivers its underlying name identifier and current IP address to the central server for updating. The service provider then uses this database to route communications between devices. Only through such updating can a member reasonably expect to receive incoming service. When a communication is initiated from a user serviced by a different service provider, there is no access to addressing information. Thus, a user having a first service provider is unable to establish a connection or communication pathway to a destination terminal serviced by a second service provider.

Static IP addresses are also in use, but are less common for client devices because of their frequent network detachment for relatively long periods before reattaching. Therefore, a substantial percentage of such statically assigned IP addresses are not in use at any given time. Additionally, as devices change ISPs, even static IP addresses previously assigned will change.

Traditional internal phonebooks may not support these new types of communications because of the changing nature of network addresses. As routing information associated with these new forms of network based communications often dynamically change, improved ways of storing and maintaining this current information is required. As the number of diverse providers offering these services increase, the need for improved ways of handling communications and tracking contacts increases. Further limitations and disadvantages of conventional and traditional phonebooks and related functionality will become apparent to one of ordinary skill in the art through comparison with the present invention described herein.

### SUMMARY OF THE INVENTION

Embodiments of the present invention are directed to systems and methods that are further described in the following description and claims. Advantages and features of embodiments of the present invention may become apparent from the description, accompanying drawings and claims.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 is a system diagram illustrating network infrastructure operable to support calls between client telephony devices, each having visual phonebook displays constructed from one or more local and remote, adaptive phonebook databases in accordance with the present invention;

FIG. 2 depicts the associatively coupled information that may be contained within the one or more adaptive phonebook database illustrated in FIG. 1, and in accordance with an embodiment of the present invention;

FIG. 3 is a schematic block diagram illustrating exemplary circuitry found within one of the client terminals of FIG. 1, according to one embodiment of the present invention;

FIG. 4 is a system diagram illustrating a network infrastructure operable to support network based communications through the registration and secure sharing of network addresses, user and device handles, and associated metadata from multiple service providers in accordance with one or more embodiments of the present invention;

FIG. 5 is a flow diagram that illustrates how information or communications may flow between client devices and service providers based on one or more phonebook databases, and to facilitate a call or communication between the first client device and a destination client device in accordance with one or more embodiments of the present invention;

FIG. 6 depicts various display sequences of a client telephony device screen, each sequence illustrating various interaction with one or more phonebook databases to facilitate a call or communication exchange in accordance with one or more embodiments of the present invention;

FIG. 7 depicts various further examples of a client telephony device's screen which displays select portions of content, including media types and available networks, from one or more phonebook in accordance with one or more embodiments of the present invention;

FIGS. 8A and 8B provide logic flow diagrams illustrating the method of servicing a call between a source client terminal and a destination client terminal wherein the source and destination client terminals are serviced by differing service providers in accordance with one or more embodiments of the present invention;

FIG. 9 provides a logic flow diagram illustrating how individual client devices may communicate to a network address information and meta data to a service provider or third party database in accordance with one or more embodiments of the present invention;

FIG. 10 provides a logic flow diagram describing an IP communication management application from a third party database; and

FIG. 11 provides a logic flow diagram describing how an individual client terminal may update network address information to a service provider or third party database in accordance with one or more embodiments of the present invention.

### DETAILED DESCRIPTION OF THE INVENTION

Preferred embodiments of the present invention are illustrated in the FIGs., like numerals being used to refer to like and corresponding parts of the various drawings.

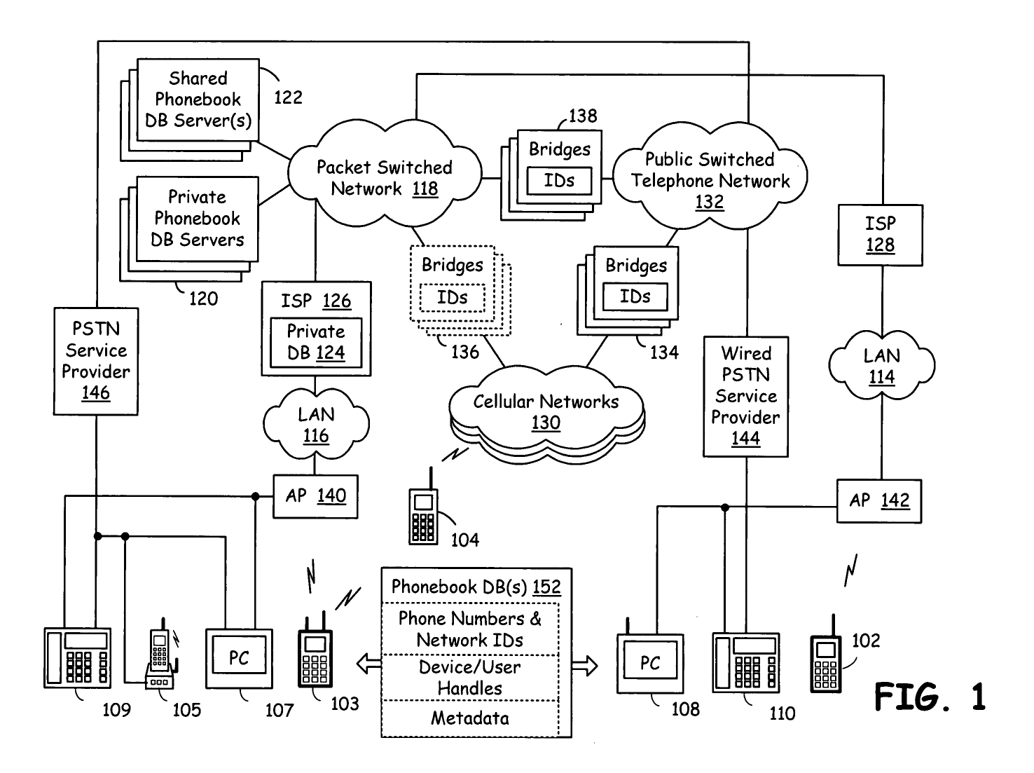

FIG. 1 is a system diagram illustrating network infrastructure operable to support calls between client telephony devices, each having visual phonebook displays constructed from one or more local and remote, adaptive phonebook databases in accordance with one or more embodiments of the present invention. Therein, each of a plurality of client telephony devices utilizes one or a plurality of wired and/or wireless interfaces to initiate, receive and maintain call sessions. Various upstream networks provide the call session pathways between such interfaces of two or more of the client telephony devices.

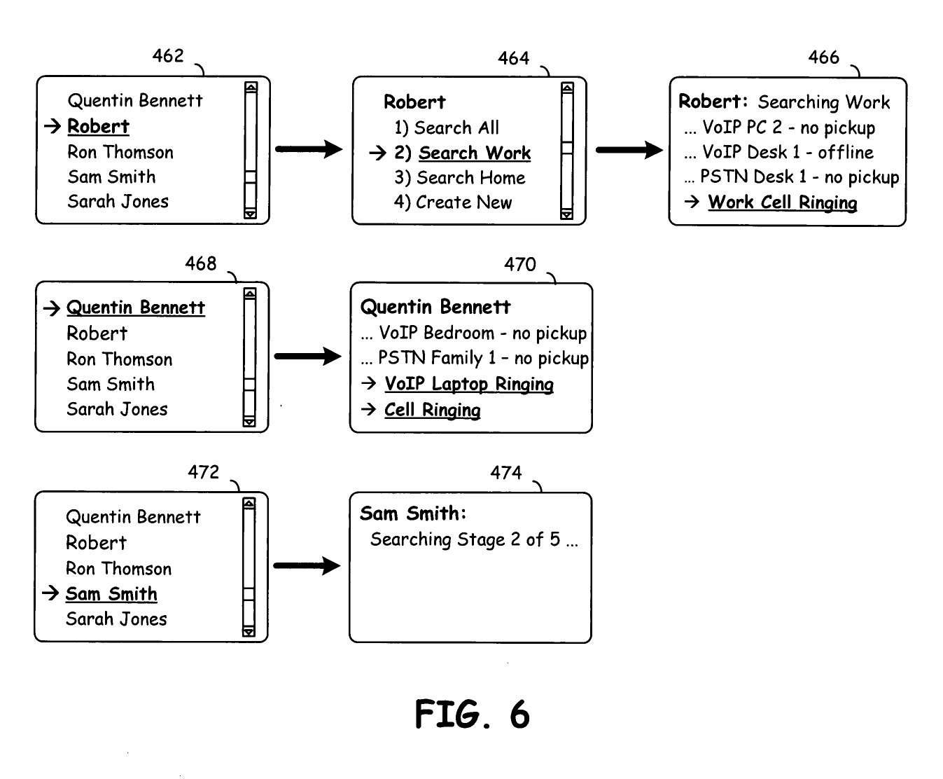

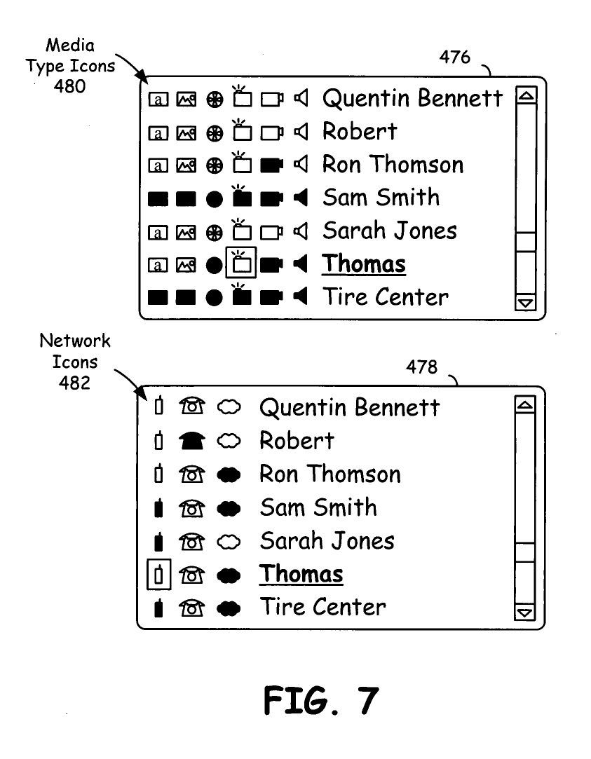

Client side phonebook application software (not shown) may run on each client telephony device, while server side phonebook application software runs on each server. These client and server software applications maintain updated information regarding the various client telephony devices via entries to the phonebook database(s). Each client software application also presents on-screen phonebook display sequences such as those presented in FIGS. 6 and 7, so that a user of the client telephony device can establish and maintain call sessions.

Exemplary information stored in a phonebook entry includes identity of all of a potential recipient's client telephony devices, capabilities of such devices and bandwidth limitations, potential recipient handles, network addresses, telephone numbers, etc. The phonebook database accessed by the phonebook management software may be local, remote or distributed there between. A local phonebook database (portion) may be stored within the client telephony device itself. A remote phonebook database (portions) is distributed across others of the client telephony devices and/or across one or more supporting servers. Such distribution may be on an entry by entry basis or based on the type of information being stored. For example, most of the phonebook entries might be stored locally while some are retrieved as the need arises, or personalization information for all entries might be stored locally with the remainder of the phonebook entry information being remotely stored and maintained.

For example, a user, through interaction with the phonebook application software may be able to select someone to call, i.e., a recipient, evaluate the capabilities of the recipient's currently available client telephony devices, consider the recipient's recent activity, and select pathways and procedures for establishing a calling session with the recipient.

Within the network infrastructure, a variety of exemplary types of client telephony devices are supported. Some of the client telephony devices are handheld devices such as cordless phone 102, cellular & Internet telephony device 103, cellular phone 104 and Internet phone 106. Other client telephony devices comprise computing devices such as PC (Personal Computer) 107 and 108. Yet others comprise desktop phones, such as desktop phones 109 and 110. Client terminal 108 is a personnel computer. Client terminal 108 may be a cellular or wireless telephone. Client terminal 110 may be a wireless local area network (WLAN)/cellular telephone operable to communicate either through a WLAN or cellular telephone network. Client terminal 112 is a laptop computer. Client terminal 104 is a wired terminal such as a PSTN telephone.

These client terminals may support wired or wireless communications according to one or more communication protocols including, but not limited to, Wireless Local Area Network (WLAN) protocols such as IEEE 802.11a, b, g, and n, Wireless Personal Area Network (WPAN) protocols such as Bluetooth, cellular protocols such as GSM, IS-95, 1xRTT, 1xEV, etc., and/or other wireless protocols. Client terminals may also support wireless communications via cellular telephone networks 130 and in the case of client terminal 103 wireless communications via a wireless network interface to an associated access point such as access point 140. Further, each of the client terminals may also support one or more wired communications and wired communication standards, including one or more versions of the Ethernet standard and/or other wired standards.

The network infrastructure in FIG. 1 further includes local area networks (LAN) 114 and 116, a packet switch network 118, such as but not limited to the Internet, public switch telephone network (PSTN) 132, cellular telephone networks 130, database servers 120 and 122, private database 124, PSTN service providers 144 and 146, access points (AP) 140 and 142, network bridges 134, 136, and 138, and packet switch network service providers 126 and 128. The wired links include actual wires, optical connections, and/or wired equivalent connectivity.

Servers 129, 122 and private database 124 couple to the packet switched network 118 and may communicate with the client devices 102 through 110. This may be accomplished through wired or wireless links such as those provided by LAN 114 and 116 or AP 140 and 142. These links allow client terminals to access the distributed phonebook database contained within the servers. Further, remote and locally portions of the phonebook database may be updated by phonebook application software executed within this network environment. To support and facilitate calls, the client devices each use client side phonebook application software and phonebook database(s) (either local or remote). Various mechanisms may be used to update the local and remote phonebook databases. In one instance, the local phonebooks are only updated through direct interaction and without any server support. Alternatively, the local phonebooks may be updated through interaction with one or more public/private databases. Furthermore, other client device(s) may use the client side phonebook application software without a local database. In this case, the information used comes from the remote (i.e. network based) database. Cellular phone 104 may use GPRS/EDGE or other cellular data pathways for a shadow version of a remote database. Additionally, any combination of the described methods may be used to provide current information to the phonebook database(s).

Access points 140 and 142 are operable to support a WLAN protocol such as one or more of the IEEE 802.11 communication protocols and/or a WPAN communication protocol such as the Bluetooth protocol.

Client terminals may associate with one or more access points or networks at any time. For example, client terminals 102 and/or 104 may be members of LAN 114 and the WLAN of AP 142. These associations may change over time. For example, if client device 102 moves within the coverage area of access point 140, client terminal 102 will associate with access point 140. Further, when client terminal 102 is within the operating range of other access points, client terminal 102 will associate with these access points as well. However, when client terminal 102 moves outside of one or more of the operating ranges of any access points, it may disassociate (by default) from one or more of the access points. This and other live information may be updated to the phonebook database to ensure current addressing information is available.

The association of the client terminals with the various wireless and wired networks results in the client terminals potentially being assigned a number of (Internet Protocol) IP addresses. The client terminals may then associate internally their username, handle or identifier with their network address (i.e. IP address in the case of internet communications). The client terminals then share the addressing information and cross reference identifies with service providers or public/private databases via the portion of the phonebook application software executed within the client terminals.

The network infrastructure provided in FIG. 1 may support call exchange between a first client terminal and a second client terminal. The first and second client terminals are serviced by the same or different service providers. In these embodiments the client terminals access, a phonebook database (local or distributed) through phonebook application software to retrieve addressing information using a cross-reference identifier, i.e., user name, handle. The client terminal may use a user name, handle, or other like identifier as an input, as a cross-reference identifier, in order to retrieve an IP address or address vectoring information in order to initiate and manage calls between client terminals serviced by different service providers. As an individual user may be associated with more than one device, calls may be directed to a number of devices wherein the selection of devices may be prioritized. This information may be stored locally or remotely to servers accessible through the network.

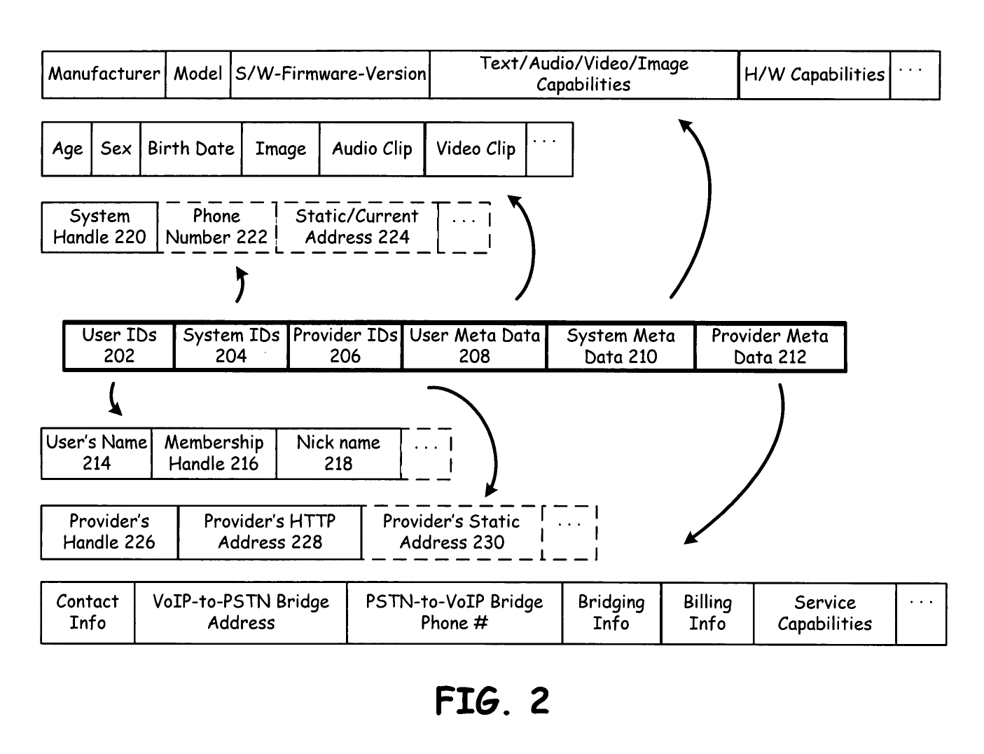

Client terminal identifiers, such as a username or handle, may, like an email address, contain a first part that identifies the user and a second part that identifies the host or service provider. Additionally, each client terminal may be assigned at least one unique IP address when registered with a servicing Internet Servicing provider (ISP) which may change over time. Client terminals register with the service provider in order to enable communications via the service provider. Either the client terminal or the service provider may then store a network or IP address associated with the client terminal and username, identifier or handle within the phonebook database. Contained within the phonebook database is information such as that discussed with reference to FIG. 2. As an individual user may be associated with more than one device, calls may be directed to a number of devices. Furthermore, as the individual devices may be associated with more than one user, the announcements of an incoming call to individual devices may be prioritized based on information contained within the phonebook database and client terminals.

Client terminals may further maintain local status parameters of that client terminal and associated and current users. The current user may be pseudo-permanently preset to a specific user, or may change as a user interacts with a device. For example, logins with or without passwords (including “guest”) may be associated with each device or may merely involve one or more button selections to identify the user before the device can be used. In case of PC client terminals, the operating system user login identity may be borrowed. Each client terminal may receive current status parameter information if authorized from each other device regarding such other devices and associated and current users. Each device may also maintain and exchange all or a portion of the status parameters from other devices outside the immediate family such as friends and business associates.

Individuals' client terminals may associatively store client handle, metadata, and network address information associated with individuals to which calls may be directed within a local phonebook database 152. This information may be stored internally within each of the client terminals or may be stored to a local database 152. When stored to a database this information may be accessible through a servicing network such as a LAN, WAN, WPAN, or the packet switch network.

Metadata associated with users and client handles may be used to manage network based communications (call delivery) to the client terminals. For example, a user or client handle may be primarily associated with an individual client terminal, such as client terminal 110. In one example, client terminal 110 may be located within home office. However, metadata contained within the client terminal or phonebook database may indicate that the user or client handle primarily associated with the home office client terminal may be available via a wireless client terminal 105. The phonebook application may determine the likelihood of user proximity to individual client terminal based on current location information, historical information, time of day information, user provided information or other like information. Instead of primarily routing the call to user terminal 110, the call may be routed to wireless client terminal 105. Alternatively, another embodiment may initially deliver the network based communication to the client terminal having the greatest likelihood of user proximity to the client terminal and then proxied to another client terminal. For example, again the call may initially be delivered to a client terminal located in the home office such as client terminal 110. When the call is not successfully delivered to client terminal 110, an announcement either audible or visual may be displayed on all client terminals associated with the user.

Alternative to proxying or forwarding of the call, a call may be routed from client terminal 110 to an alternative client terminal such as wireless terminal 105. This may be done by informing the initiating phonebook application within the client terminal of a new network routing address of the client terminal to which the network based communication is routed. This may be accomplished by the phonebook application within the intended destination to terminal updating the phonebook database when the call is initially received. This updated information may then be used to announce the call.

FIG. 2 depicts examples of associatively coupled information that may be contained and associatively stored within the one or more phonebook database in accordance with an embodiment of the present invention. The information may be stored within phonebook databases on client terminals or servers available through the network. This data may be populated through web-based interfaces, from other databases, or reports from client terminals and service providers to the phonebook database. The reports may be made by phonebook application software running within client terminals, service provider servers, or other applications that sample publicly available databases. For example, a database associated with PSTN phone numbers may be sampled to populate certain network addresses wherein these network addresses are traditional phone numbers as opposed to being an IP address.

This phonebook database, although described as being accessible and shared through a network connection, may be available through a private or public network connection. For example, a service provider may have a private database shared by subscribers or an enterprise may have a private database accessible through an internal intranet. Client terminals having users authorized to access the phonebook database may exchange information with the database. Personalized phonebooks may be stored either on the network or within internal memory within the client terminals.

This phonebook database associates client handles or identifiers with routing identifiers (network addresses (i.e. telephone numbers associated with a PSTN) or communication pathways (i.e., the current IP address (i.e. network identifier) of a network-based communication device may be contained within the network address information within the phonebook database)). Individual client terminals register upon power-up, when a roaming event occurs, or as specified by other periodicities. For example, when a user gains control over a client terminal and attempts a phonebook lookup—an update may be initiated. The request may operate locally if the local phonebook is stored locally and considered to have non-latent or non-stale data. This non-latent or stale data may be identified as data that is within a certain periodicity.

Multiple network addresses may be associated with an individual client handle. This is because multiple communication pathways may exist for an individual. These multiple pathways may describe pathways to different client terminals or alternate pathways to a single client terminal. For example, these pathways may within a circuit switched telephony network, a packet switched telephony network, or a combination of circuit switched telephony network and packet switched telephony networks. Metadata is then used by phonebook application software to determine which communication pathway is best utilized to deliver the communication. Metadata may provide a set of rules wherein the rules specify that for a certain time of day, day of the week, or other like information that one network address (communication pathway) may have a higher priority and thus be preferentially selected over another network address. Alternatively, depending on user-specified information an individual may update to the database and indicate that all incoming calls be routed to a mailbox or that only text messages may be received during a given time frame. These selections may also be made based on cost or relationship between the individual caller and the callee.

For example, a caller may pick a multi-mode phone as a client terminal to initiate a call and select a callee within the phonebook stored in the client terminal or accessed by the client terminal. Further, the caller may select an 802.11 pathway, if available, via the phonebook application because the pathway is active and provides a low-cost option. An attempt to establish the call may then be made using this pathway. Alternatively, based on security or other criteria, the caller may select an alternate callee pathway if available. Automatic or manual handoff on either side may be controlled by either both the caller and the callee.

The various cross reference identifiers depicted in FIG. 2 may include one or more user identifiers, terminal identifiers and service provider identifiers. For example, user identifiers 202 may include user name, member handle or other like information. System identifiers 204 may include a system handle, phone number, ESN, stacker card address, or other like information. A provider I.D. 206 may include a provider handle, a network address, a static address, or other like information. In addition to the user system and provider identifiers, metadata may be associated with these identifiers. For example, personal information such as the age, sex, birth date, image, audio clip, video clip, authorization information or other like information may be associated with a user. The terminal identifier may contain information such as manufacturer, model number, software version, multi media capabilities, hardware capabilities, or other like information. The service provider metadata may include contact information.

The data is associatively coupled. For example, user ID 202 may be associated with a system ID 204, provider ID 206, user metadata 208, system metadata 210 and provider metadata 212. Additionally, the user ID may be associated with a user specified or personalized field within the phonebook for a name or nickname, a user name 214, membership handle 216, a nickname 218 (a nickname may be a custom field defined by the user interfacing with the phonebook). System information contained within the phonebook database may include system handle 220, phone number 222, static or dynamic IP network address 224. Provider I.D. information may include provider handle 226, a provider network address 228 or 230. Thus, a single piece of data, or set of data fields, may be used to retrieve associated information on the potential callee to facilitate and manage calls between client terminals.

User identifiers may comprise a user's name or some “handle” that uniquely identifies a user with that service provider. A service provider identifier might comprise a web address, provider name, or the provider's static IP address. The terminal identifier might be a computer name, telephone number, or serial number, for example. User information might be nearly anything related or unrelated to the overlying service (age, sex, birthdates, etc.). Terminal information might include manufacturer, model number, firmware/software/hardware version, image/video/audio capabilities, processing power, memory/storage capability, battery capability and status, operational status, available CODECs and versions, etc. As with other metadata, the terminal information might be related or not to the overlying service. Service provider information might include zero or more of service descriptions, service characteristics/limitations, service status, billing info, etc.

This information may associate an individual username, identifier or handle with more than one client terminal. This allows a call to be delivered simultaneously to one or more client devices where the user is likely to be present based on preset or monitored activity and corresponding time of day and day of week. This likelihood may be based on history (recent and long term) and based on “online” or “active” user and device status. This information may be maintained in the phonebook database located on a remote server or within database memory of individual client terminals used to initiate calls. This functionality may facilitate call forwarding/conferencing between devices. Call forwarding, in general, can involve either a coordinated handoff of IP addresses or proxying. In the latter case, the client terminal initiating the call request need not know of or support the proxy.

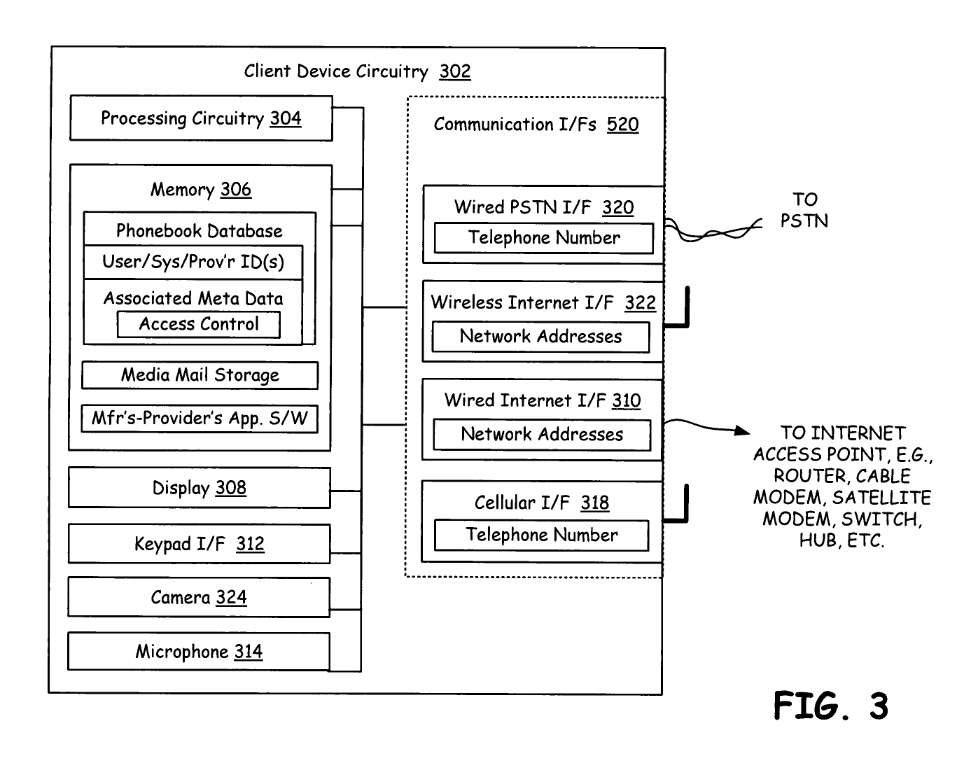

FIG. 3 is a schematic block diagram illustrating exemplary circuitry found within one of the client terminals of FIG. 1, according to one embodiment of the present invention. The telephony circuitry of client terminal 302 includes host processing circuitry 304, memory 306, display 308 and associated display interface circuitry, wired network interface 310, keypad interface 312 (i.e. user input circuitry), microphone/speaker 314, camera 324, cellular network interface 318, PSTN interface 320, and wireless network interface 322. The network interface 310, cellular network interface 318, PSTN interface 320, and wireless network interface 322 may be referred to collectively as communication interface circuitry to support both circuit switched telephony networks and packet switched telephony networks. Host processing circuitry 304 may be a microprocessor, a digital signal processor, an application specific integrated circuit, a state machine, an FPGA, and/or other circuitry that is operable to execute software instructions and to manipulate data. Memory 306 may be RAM, ROM, PROM, hard disk drive, and/or other components capable of storing software instructions and data. (i.e., the phonebook application software and local portion of the phonebook database.) Remote memory may also be available to store the contact associations of the phonebook database. Network interface 310 may support wired or wireless communications according to applicable communication protocol standards.

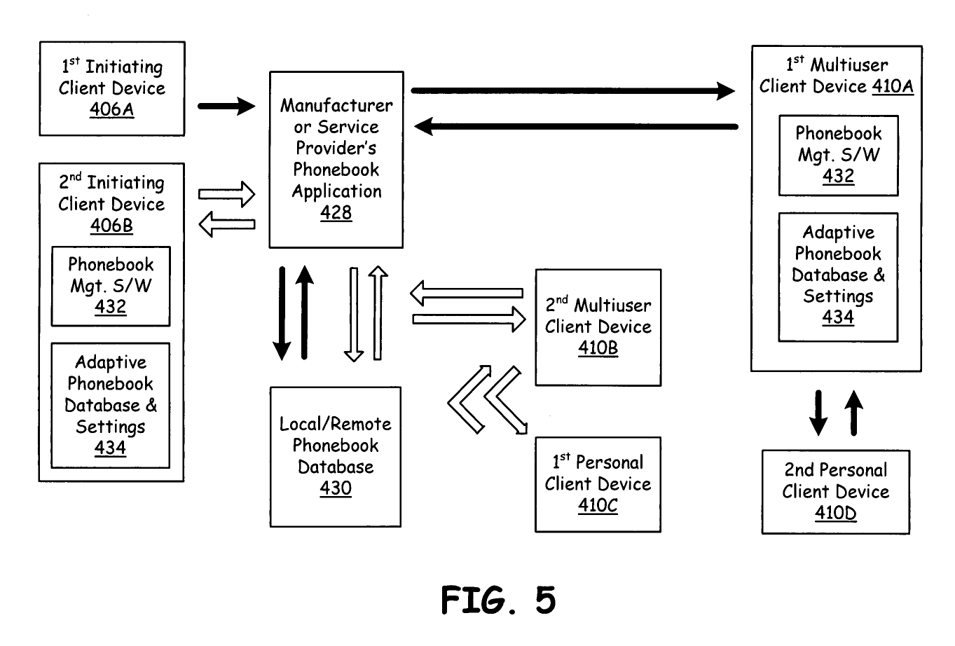

The phonebook database as discussed with reference to FIG. 2 may be all or in part stored within memory 306. Additionally, contained within memory 306 and executed within processing circuitry 304 may be phonebook application software that allows a user to interface with the phonebook database. It should be noted that although memory 306 is shown as containing the phonebook database, all or a portion of the data contained within the phonebook database may be contained and accessed through the phonebook software application via a network connection to a remote server where the phonebook database may be stored. The operation of this phonebook software application may be discussed in further detail with reference to FIG. 5 and following. This phonebook application software 328 allows the user to access information within the phonebook.

The wired network interface 310 and wireless network interface 322 may support packet switched network communications as was previously shown with reference to FIG. 1. Additionally, these interfaces may provide the status of availability information to the phonebook application software. This information may be used to update the availability and particulars of various communication pathways. Thus, the client terminal may support communications with a router, cable modem, satellite modem, a switch, a hub, and/or another device. Further, the interfaces may support WLAN communications, cellular communications, or other packet switched communications. Not all client devices utilize all of the interfaces 310, 318, 320, and 322. For example, as illustrated in FIG. 1, the client terminal 106, a personal computer, is only configured with wired interface 310.

Host processing circuitry 304 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. Memory 306 may be a single memory device or a plurality of memory devices. Such a memory device may be a read-only memory, random access memory, volatile memory, non-volatile memory, static memory, dynamic memory, flash memory, cache memory, and/or any device that stores digital information. Note that when the processing module 304 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. The memory stores, and the processing circuitry executes, operational instructions.

Client terminal and the client device circuitry 302 supports call exchange with a second or destination client terminal. This first client terminal may be serviced by a first service provider while the destination client terminal is serviced by the same or a second service provider. The communication interfaces allow the client terminal to establish communications with various available networks. Specifically, wired interface 310 and wireless interface 322 allow communication to be established with a packet switch network. When initiating a call the user will interface through the display 308, keyboard interface 312, or microphone 314 to initiate a call. Initiation of a call may involve inputting a handle that uniquely identifies the user associated with the destination terminal. The client terminal may then access a database to obtain address or vectoring information for the destination terminal. Both the initiating and destination terminals not only store information in memory 306 but may upload this information or a portion of this information to the public or private databases. In this way processing circuitry 304 may properly configure the communications with the client termination for communications with the destination terminal based on the terminal and provider capabilities as well as user-defined inputs provided to both the initiating and the destination client terminal. Additionally, it may be desirable to simultaneously establish communications via multiple communication pathways. These multiple communication pathways may support different media capabilities. For example, a first pathway may be used to support voice while a second is used to support video or images.

When multiple client terminals 302 are located within a common environment or when multiple users are sharing one or more client terminals, management of communications, both incoming and outgoing, may be required. In the case where multiple client terminals 302 are located within a common environment, each client terminal may be associated with at least one handle (user) and/or network address. These devices may know the handles and network addresses of each client terminal within this “group” of client terminals.

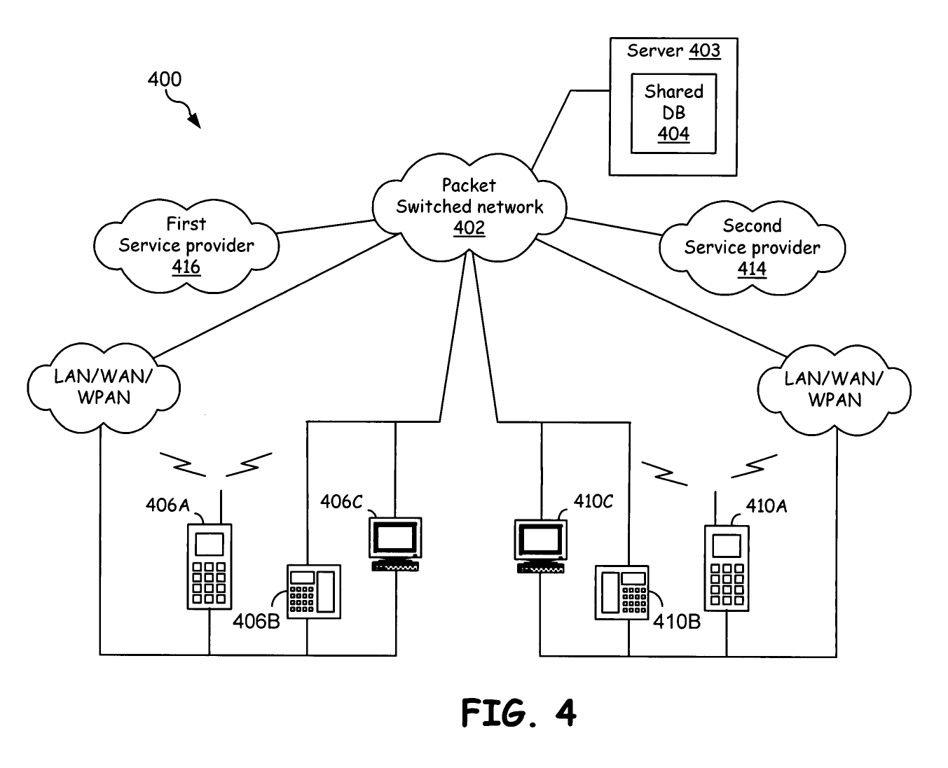

FIG. 4 is a system diagram illustrating a network infrastructure operable to support network based communications through the registration and secure sharing of network addresses, user and device handles, and associated metadata from multiple service providers in accordance with one or more embodiments of the present invention. This network infrastructure 400 includes a packet-switched network 402, a phonebook database 404, a first client terminal, such as wireless client terminal 406A, wired client terminal 406B, or PC terminal 406C, a second client terminal, such as wireless client terminal 410A, wired client terminal 410B, or PC terminal 410C, a second service provider 414, and a first service provider 416. Client terminals 406A, 406B, 406C, 410A, 410B and 410C may have a username, handle or other identifier associated with the device or user. These client terminals may support network based communications using a service provider such as but not limited to Skype, AOL's Instant Messenger (AIM), Microsoft MSN Messenger, Yahoo Messenger, and other like services that provide text and voice services.

The username handle or other identifier may be established with service provider 416 or 414. Client terminals, first service provider 416, second service provider 414, and phonebook database servers 404 may all communicatively couple to the packet-switch network 402. The service providers servicing the first and second client terminal may differ according to various embodiments of the present invention. The packet-switch network 402 may be a network such as but not limited to the Internet or other like packet-switched network.

The client terminals have identifiers such as a username or handle and may be associated with unique service providers. The username or handle may, like an email address, contain a first part that identifies the user and a second part that identifies the host or service provider. Additionally, each client terminal may be assigned unique IP address when registered with a servicing Internet Servicing provider (ISP) which may change over time. Client terminal registers with the service provider in order to enable communications via the service provider. Either the client terminal or the service provider may then store a network or IP address associated with the client terminal and username, identifier or handle within the phonebook database.

When first client terminal 406 seeks to establish or initiate a call request to second client terminal 410, the phonebook application software executed within the client terminal, phonebook database 404, which may be shared locally or hosted on web server 403, to access a network address or vectoring information associated with the destination terminal. Phonebook database 404 may contain network capabilities information, communication capabilities information, terminal capabilities information, user defined criteria, and/or security information. In one embodiment this information may describe the CODECs which are to be employed in order to support the communications between the first client terminal and second client terminal. Other types of information that may be associated with the client terminal via the phonebook database may be security information. Security information may require that the second client terminal contain authorization information for the first client terminal prior to supplying the network address to the first client terminal. In other embodiments this metadata may be CODEC capabilities, multimedia capabilities, latency information, user information, user email address information, user phone number information, VoIP client terminal location information, quality information, VoIP service provider, session information, network information, call authorization criteria, pathway information, port information. User defined metadata may describe how calls are to be handled based on the time of day user, time of day for the call request, time of day for the client terminal(s) associated with the destination IP addresses, day of week for the user, day of week for the call request, day of week for the client terminal(s) associated with the destination IP addresses, geographic location of the user, geographic location initiating the call request, geographic location of the client terminal(s) associated with the destination IP addresses, expected proximity of the user to the VoIP client terminal(s) associated with the destination IP addresses, and/or the relationship of the user to a party initiating the call request to the user receiving the call.

In other embodiments, these client terminals may be associated with a number of network addresses. Individual network addresses may be associated with the type of incoming call, the specific communication pathway, or other factors associated with the communication. For example, a client terminal may have one IP address for each communication pathway or link. This may be realized as specific addresses for voice communication and other IP addresses for a text, multimedia or audio/video communication. Other network addresses may be available for technical support.

Vectoring information to the service providers may be retrieved in place of specific network addresses associated with individual client terminals. Thus, when a first client terminal initiates a call or call request, the first client terminal retrieves vectoring information from phonebook database 404. This vectoring information may include a second service provider network address that directs the first client terminal to the second client terminal. The second service provider then provides the network address of the destination client terminal directly to the first client terminal. The first client terminal then may use the network address to establish a call with the second client terminal.

FIG. 5 is a flow diagram that illustrates how information or communications may flow between client devices and service providers based on one or more phonebook databases, and to facilitate a call or communication between the first client device and a destination client device in accordance with one or more embodiments of the present invention. This flow diagram shows how information may flow to facilitate a call or communication between a first client device 406A and the destination client device or terminal 410A. Each client device or client terminal may contain in local memory or have access to a phonebook database. In this first example, a phonebook application 428 within the initiating device accesses a local or remote phonebook database 430 that contains the stored phonebook information. Additionally, each client device may automatically update this address information to the network to ensure the information contained within database 430 is up to date. This local database may be associated with the multiple client devices of family 426, calls may be directed to a number of devices wherein the selection of devices may be prioritized.

Client terminals 410A-D may maintain local status parameters of that client terminal and associated and current users within adaptive phonebook database and settings 434 stored within local memory and manager by phonebook applications software 432. Each device may also update database 434 and exchange all or a portion of the status parameters from other devices such as those belong to friends and business associates with remote phonebook application software 432. This is accomplished by communicating this data to other client device or network 428 available resources.

Metadata associated with users and client handles may be used by the phonebook application software to manage network based communications (call delivery). For example, a user or client handle may be primarily associated with an individual client terminal, such as client terminal 410D. However, metadata stored to the phonebook databases may indicate that the user or client handle primarily associated with client terminal 410D may be available via a client terminal 410A.

The priority of devices chosen to receive the call may be determined by the sending, receiving, and network service provider phonebook applications. The flow of the call from initiating device 406A indicates that the call may be directed to devices 410A and 410D. Client device 410A may be a multi-user device associated with the intended call recipient while device 410D is a personal device that may be uniquely associated with the intended call recipient. This call may be delivered simultaneously to these devices or sequentially (i.e. first personal client device 410A and then multi-user device 410D).

In a first example, initiating client device 406A accesses remote phonebook database 430 and 410 via network based phonebook application software. The phonebook database(s) may be dynamically updated by the various phonebook applications to ensure that the network address or vectoring information associated with destination client device 410A is current. This information may be updated with phonebook application software. This information may be shared to other client devices such as client device 406B which will initiate a second call as will be discussed in the second example. Client device 410A on receiving the call if the intended user is unavailable may proxy or forward the call as directed by the local phonebook application running within device 410A to a second client device 410D. For future calls, the forwarding information may be provided back to the network or maintained solely within 410A, depending on user specified preferences.

In another example, initiating client device 406B maintains local up-to-date information as provided via a network based phonebook application 428. In this way the initiating client device does not need to access a remote database 430 for each call but may immediately direct the call to destination client device 410B based on information stored. As shown here client device 410B does not need to maintain a local phonebook but uses a network interface to maintain local phonebook 434 with remote phonebook database 430. Should the intended user not be client device 410B as determined by interactions between client device 410B and software application 428, this call may be redirected to a second client device 410C where the intended user is available.

FIG. 6 depicts various display sequences of a client telephony device screen, each sequence illustrating various interactions with one or more phonebook databases to facilitate a call or communication exchange in accordance with one or more embodiments of the present invention. In a first example, the phonebook application software presents to the user several display screens that facilitate initiating a call. Scroll down menu 462 initially allows a user to highlight and select an individual recipient by a contact handle or recipient identifier. Once a recipient has been selected, a second display 464 may be presented. Then, display 464 allows the user to determine how the call should be routed to the intended destination. For example, the call may be routed to all available addresses associated with the intended user or a subset such as those associated with “work” or “home.” As shown here, the “work” network addresses are selected to be searched. Once selected status screen 466 is displayed. Status screen 466 depicts a status of placing the call to these “work” addresses. As shown within status display screen 466, the call is attempting to be placed, however, an attempt to deliver via a traditional PSTN phone failed as well as two VOIP options that were available. These options may be prioritized. In this case perhaps the PSTN was contacted first, followed by a first VoIP address, then a second VOIP address which is then followed by a cellular connection.

In a second example, depending on how the adaptive phonebook application software is configured and what preferences are entered by the user, a call may be simultaneously delivered or sequentially delivered to every available network address associated with the intended user. In this case, display screen 468 allows the user to choose a recipient (i.e., “Quentin Bennett”). Then display 470 presents the status of attempting to deliver the call to the various terminals associated with “Quentin Bennett.” Display screen 470 indicates that the first subset, (i.e. a VoIP and PSTN address) were first attempted and then the VoIP laptop and cell phone are being contacted simultaneous to establish a call.

In a third example, “Sam Smith” is selected on display screen 472 after the intended callee is identified, the application may simply describe the process of searching for the callee does not necessarily identify display 474 the destinations that it is attempting to contact.

FIG. 7 depicts various further examples of a client telephony device's screen which displays select portions of content, including media types, recipient availability, and available networks, in accordance with one or more embodiments of the present invention. In exemplary display screens 476 and 478, icons are used to convey additional information. For example, icons may indicate available media type and networks available with individual callees. Alternatively, they may indicate the availability of the recipient to the callee. As shown, different communication capabilities may be associated and displayed by the phonebook application software. The client and server phonebook application software may interact to update the phonebook databases with network addressing, link availability, and pathway performance characteristics or communication pathway capability information. For example, associated with each pathway are link availability status icon(s) and pathway performance characteristic icon(s) that may be displayed to the user. Parameters for each are stored within memory, typically in a database, and in association with the handle of the contact (i.e. recipient). The link availability icon(s) and associated one or more parameters indicate that the link is down or available, the recipient device is sleeping, powered down, available, or in use. This may also indicate what media capabilities and costs are associated with the link. The recipient device status, such as do not disturb (DND), text messages only, on a call, offline, on-vacation, in meeting, at-home, at-work, sick, etc., could have one or more graphical identifiers associated with the contact handle. These would of course apply to each and every pathway, and each and every recipient telephony device. The pathway performance characteristic icon(s) and one or more associated parameters indicate that pathway bandwidth, QoS, delays, media type limitations, and security requirements. This helps to ensure that current data, received by the server phonebook application software can update remote phonebook database or be distributed to client phonebook application software to update local phonebook database(s). The results of these interactions may be summarized in the exemplary displays.

Display 476 contains icons 480 (i.e. pathway performance characteristic icon(s)), which represent the media types that the intended callee may receive. For example, the callee, “Thomas,” may be able to receive a video call, a picture a text message, or a voice message as indicated by the non-darkened icons. The types of communications that the callee can receive may be indicated by highlighted icons while a darkened icon indicates the inability of the callee to receive that type of communication. This may be updated dynamically depending on the client devices that are active or associated with the callee wherein this information is provided to the adaptive phonebook.

Display screen 478 indicated what kind of network communications the callee may receive wherein the status is indicated by individual icons 482 (i.e. link availability status icon(s)). For example, here a cellular icon, a PSTN icon and a VOIP icon may be associated with individual callees wherein the availability of the callee through these networks is indicated through the icon. For example, “Robert” may be available via a cellular connection or a VOIP connection but is unavailable via PSTN as indicated by the darkened PSTN icon. The user may then highlight individual icons and select that as the means of delivering the communication or call to the intended callee.

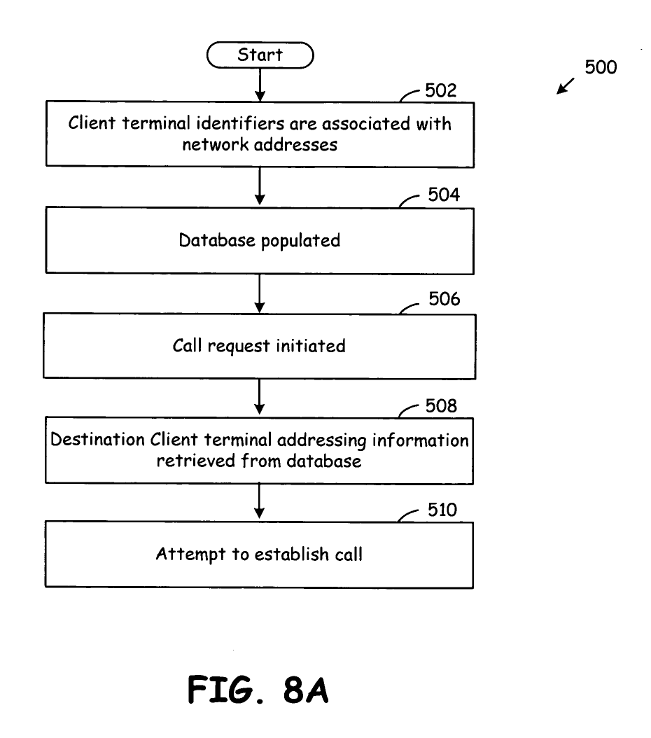

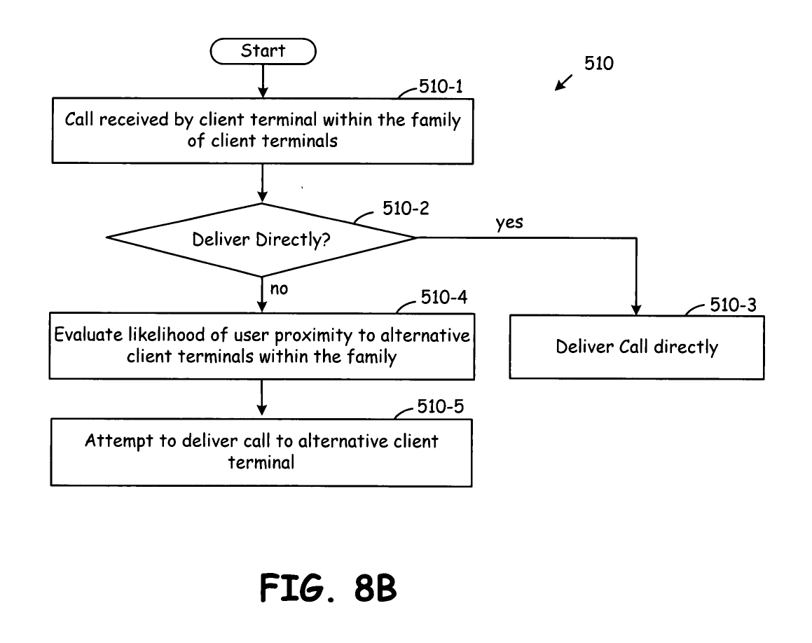

FIGS. 8A-11 provide logic flow diagrams that relate to specific operations performed in accordance with embodiments of the present invention. FIG. 8A provides a logic flow diagram illustrating a method of servicing a call between a source client terminal and a destination client terminal. Operations 500 begin with step 502. In step 502, client terminal identifiers are associated with client terminal network addresses. These associations are stored within a local phonebook database or remote phonebook database available through a network connection. This process may be facilitated with phonebook application software executed locally on the client terminal or remote network computing devices. After this phonebook database has been populated in step 504, the local or remote phonebook database may be accessed to service call requests initiated from a client terminal in step 506. This call request, which may be initiated with phonebook application software, should include a destination identifier such as a username, handle or other identifier. In step 508, the phonebook database is accessed based on the destination identifier within the call request to retrieve one or more network addresses associated with destination client terminal(s) for the intended callee. This information may be presented in the displays discussed with reference to FIGS. 6 and 7. In step 510, the source client terminal may then attempt to establish a call with the destination client terminal using the network addresses and other related information retrieved in step 508.

FIG. 8B describes operation 510 which is associated with an attempt to deliver a call, in further detail. Using the phonebook database and the information contained therein, the phonebook application software may facilitate a call directed to a client terminal in step 510-1. At decision point 510-2, it is determined whether or not the call is successfully delivered to the intended destination. If it is, the call is established and managed according to normal call operations in Step 510-3. Otherwise, the phonebook application software of either the client terminal or the network may determine an alternate client terminal or network address to which the call is to be directed. Then, in Step 510-5, an attempt to deliver the call to the alternate client terminal is processed. If the call is successful, normal operations continue. Otherwise, this process may be repeated by returning to Step 510-4 where yet another alternative network address or client terminal may be identified based on the metadata contained within the phonebook database(s). This may involve the phonebook application of the destination client terminal determining if the call is to be proxied or forwarded. Then, the network or local phonebook application software may determine if any other alternatives exist. Additionally, the results of the processes may be used to further update the phonebook database(s). By updating the phonebook database in this manner, another call initiated by another user to the same destination may avoid the initial failed call attempt described above.

Additionally, the phonebook application software may use information within the phonebook database(s) to define the communications type between the source client terminal and the destination client terminal. This may involve determining terminal and network capabilities, such as the ability to support a voice communication, such as VoIP or any combination of voice, audio, video, text or between the source client terminal and destination client terminal.

The data contained within the phonebook database may be periodically updated. As IP addresses are dynamically assigned, it may become necessary for client terminals to update phonebook database(s) periodically or when a specific events occur. These periodic updates maybe done using messaging services such as, but not limited to, text messaging, short-messaging services (SMS), email communications, instant messaging (IM), enhanced messaging service (EMS), and multi-media messaging services (MMS).

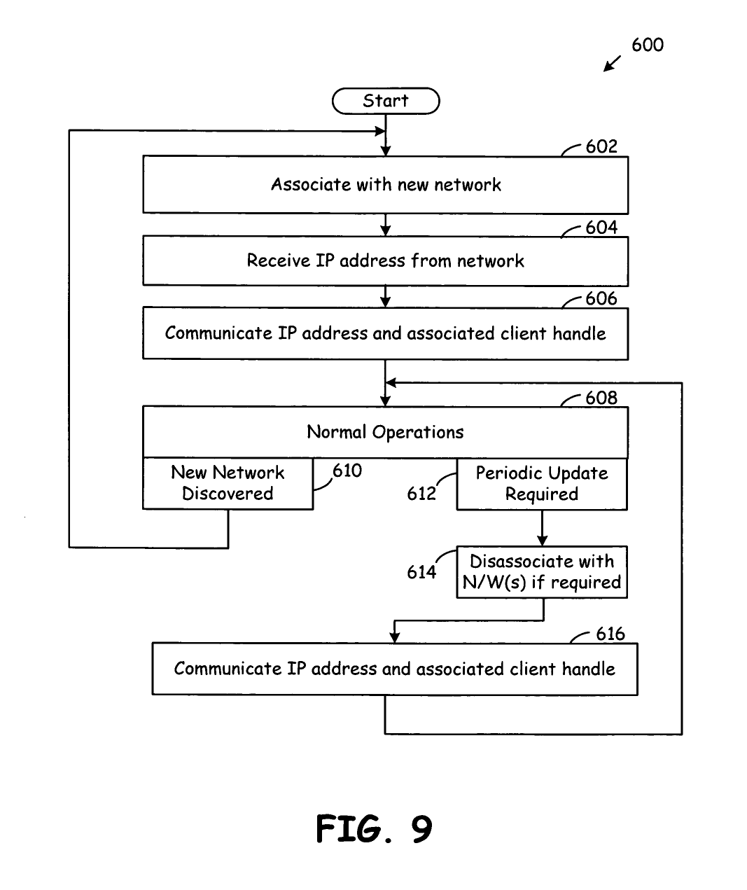

FIG. 9 is a flow chart illustrating operations 600 according to one embodiment of the present invention. These operations commence with a client terminal associating with a particular network in step 602. This new network may be a wireless network or a wired network. Upon association with the new network, the client terminal exchanges user information with the new network and the new network registers the client terminal. Registration may require password exchange from the client terminal to a point of access of the network, e.g., access point 140 or 142 of FIG. 1. The network then assigns a unique IP address to the client terminal and transmits the IP address to the client terminal in step 604. In response to receiving the IP address from the network, the client side phonebook application software running in the client terminal communicates the IP address and additional information (i.e., username, handle, identifier and other metadata) to server side phonebook application software running within the network to update remote phonebook database(s) in step 606. For each IP address, the client terminal may report metadata as directed by the phonebook application software, such as the new network type, current loading parameters of the new network, current noise/interference properties of the connection that the client terminal has to the new network, location information, security information and/or power usage characteristics performed by the client terminal in communicating with the new network. Additional information or metadata that may be reported by the client terminal may further include the cost associated with communicating via the new network, a user desirability of communicating via the new network, security information regarding the new network, and an access point IP address of the new network with which the client terminal associates, if available.

For example, with reference to FIG. 1, client terminal 102 may roam to the service area of access point 140 from the service area of access point 142. In this example, the client terminal is previously associated with access points 142 as well as with access point 140. Upon associating with the new access point 140, client terminal 102 becomes associated with the access point 140 and receives an IP address. In response, the phonebook application software within the client terminal communicates the new IP address from access point 142. Further, with the IP address reported, the client terminal may disassociate the client terminal from the previous network.

Referring again to FIG. 9, after communication of the IP addresses and the additional information is complete, normal operations are established in step 608. When the client terminal discovers another new network in step 610, operation returns to step 602. During normal operations 608, the client terminal may determine that a periodic update is required in step 612. This update may be required by the phonebook application software according to a predetermined schedule or other criteria. The update may require that the client terminal disassociate with one or more networks with which it is currently associated in step 614 in order to remove stale information from the phonebook database. When the client terminal disassociates with a network, the IP addresses and additional information may be directly or indirectly communicated to the phonebook database so that latency of addressing information within the phonebook database is reduced. From step 616, operation returns to step 608.

The identity of the client terminal device receiving the call may be used to update the database for future incoming calls. In this way, the client terminal receiving the call is at least temporarily assigned a higher likelihood of proximity to the user.

A call conferencing situation may arise in a home, where multiple client terminals are “associated” and ring together, in sequence or round-robin ringing) if the intended recipient is unidentified or whereabouts within the house are unknown. In one embodiment, the phonebook database has knowledge of such association and delivers pluralities of IP addresses to the caller's system to perform such call functionality. In another, a local server acts as a proxy or branch exchange to establish the ring pattern to the association and delivers only a single IP address upon pickup to the calling system.

In yet another embodiment, each associated client terminal knows the current IP address of the associated others. The phonebook database delivers one of the IP addresses to the client terminal initiating the request. The initiating client terminal sends a call request to the single IP address provided. The recipient client terminal then contacts the other associated client terminals to manage the call pattern. If the recipient client terminal answers, the call continues using the recipient's network address. Alternatively, if an associated client terminal answers, either the recipient acts as a proxy for the answering client terminal without troubling the calling system or the recipient and/or answering client terminal coordinate an IP handoff with the calling system.

Some network connections are not robust or the addressing information may become stale. The former is the case when a client terminal is on the fringe of a wireless coverage area and/or when the client terminal is roaming outside its normal service area. Further, the client terminal may be engaged in some activity such as participation with another network or may be asleep with respect to a particular network. Such other activity may prevent direct receipt of packet data based call directed at a specific network address. In such cases, indirect delivery may be attempted.

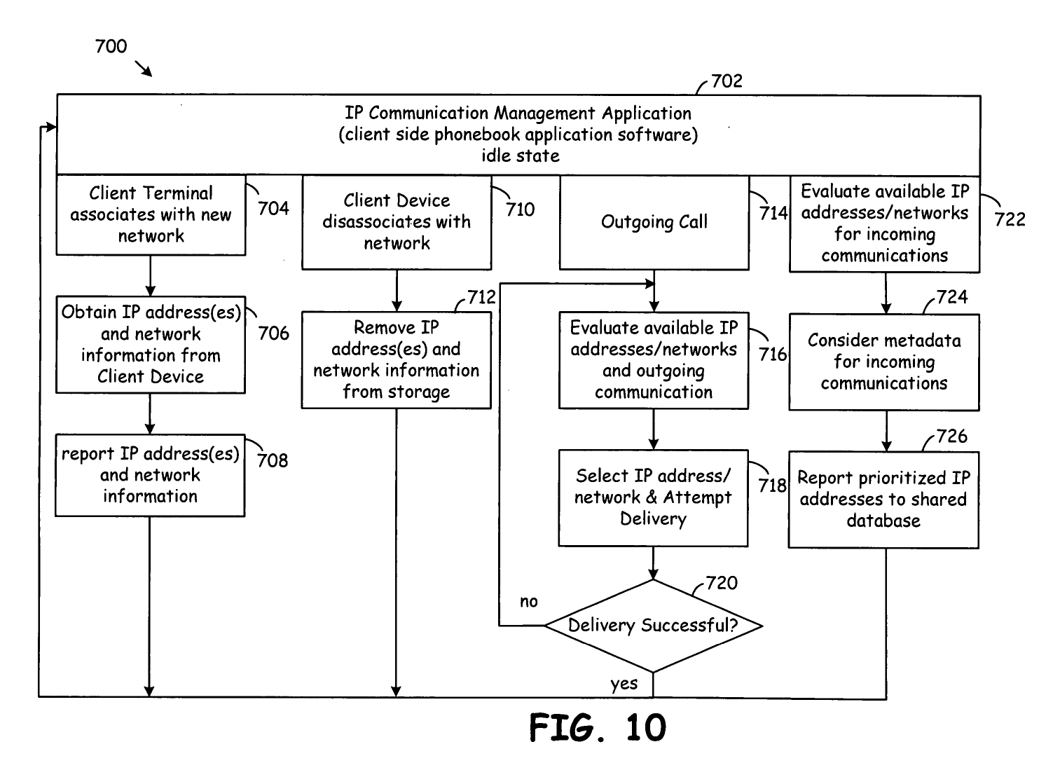

FIG. 10 is a flow chart in accordance with an embodiment of the present invention. Operations 700 may be performed by phonebook application software operating on a client terminal or server within the service provider. This application is operable to manage all available communication resources for the client terminal. For example, when the client terminal supports multiple network types, e.g., Bluetooth, WLAN, and LAN, this application keeps track of all of available network based communications. When client terminal example 102, associates with an access point, as was described with reference to FIG. 1, this network may provide a unique IP address to client terminal 102. The application running on the client terminal knows the IP addresses of each of the available network IP pathway options. The client application may also be operable to collect statistics related to each network connection. For example, data related to the performance of the connection, bandwidth of the connection, and the costs associated with the connection may be monitored using the client application. Then, based on all of the previously identified and collected information, when a particular task requires an IP pathway, the application assigns one of the pathways for the transaction. This information may also be reported to the phonebook database in order to manage incoming communications. The client application may, after priorities assigned to various IP addresses within the phonebook database, define the priorities of network addresses reported as being available to the phonebook database. This may be done based on the network capabilities, terminal capabilities, communication capabilities, and/or user input. For example, in a low bandwidth environment, the client application may assign a higher priority to a network address associated with a text messaging communication pathway rather than a voice communication or audio/visual communication pathway. This is because insufficient bandwidth is available to support these more robust communications. Alternatively, a user may direct, through the user interface or keypad of the client terminal, that only text communications should be received or that the device be placed in a privacy mode where text communications or voice communications are routed to an appropriate mailbox. In this way, the client application not only manages the routing of outgoing communications, but may also manage the routing of incoming communications.

Operations 700 of FIG. 10 commence with the IP communication management application (which includes the client side phonebook application software) operating in an idle state in step 702. From step 702, the client terminal may associate with a new network in step 704. In the association, the client terminal will receive an IP address and network information from a servicing access point or network. In response thereto, the IP communication management application obtains such IP addresses and network information from the client device in step 706. The IP communication management application will then report the IP addresses and network information received for the particular IP pathway in step 708 to update phonebook database(s). From step 708, operation returns to step 702.

In another operation, the client device disassociates with a particular network in step 710. In such case, the IP communication management application removes the IP address or addresses associated with the network and the network information from the phonebook database(s) in step 712. From step 712, operation returns to step 702.

In yet another operation, the client terminal desires to establish communications in step 714, (e.g., to a destination client terminal). In response thereto, the IP communication management application evaluates the type of communication desired and the available IP addresses and networks with which the client terminal is associated in step 716). This evaluation may involve inputs from both client side and server side phonebook application software and their interaction with both local and remote phonebook database(s). Based upon this evaluation, the IP communication management application selects an IP address and a network for the packet data communication transmission and attempts delivery via the selected IP pathway in step 718. If delivery is not successful (as determined at step 720), operation returns to step 716. However, if the delivery is successful as determined at step 720, operation returns to step 702.

To support incoming communications, the client application is operable to evaluate the available IP addresses and networks in step 722. In step 724, user preferences will be considered for the prioritization of IP addresses for incoming communications. In step 726, the prioritized IP addresses and metadata associated with communication types and the various capabilities of the terminal network and communications are reported to the phonebook database(s) such that the client application manages not only outgoing communications but incoming communications as well

With operations 700 of FIG. 10, the IP communication management application may consider the data type for incoming and outgoing communications, a latency of each IP pathway, the cost of each IP pathway, and other relevant IP pathway considerations. For example, for some packet data servicing, the IP communication management application may select a low cost IP, high latency IP pathway for some type of communication, such as low priority text only, while selecting a low latency, high cost IP pathway for other types of packet data, such as voice or audio/visual communications. The IP communication management application may also select a particular IP path for packet data transmission based upon the network operational parameters of the available networks associated with the client terminal. For example, the IP communication management application may evaluate the traffic loading of the various available IP pathways prior to selecting an IP pathway for a particular packet data communication.

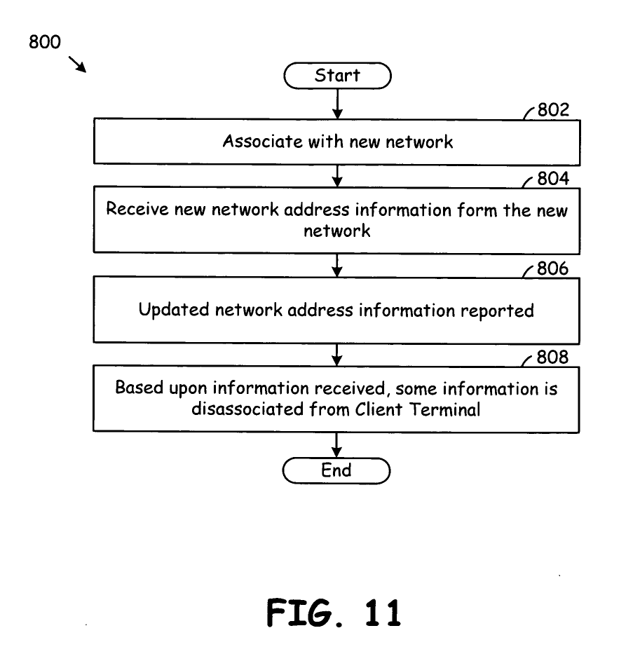

Operations 800 of FIG. 11 are particularly useful when the client terminal is mobile. Due to mobility, when a client terminal associates with a new network in steps 802 and 804, the client terminal may be outside the communication range of other previously associated networks. This data is used to update the database(s) in step 806. Prior addressing information may have become stale. Based on the current information, a previously associated address may be disassociated from the client terminal based upon the fact that the client terminal is now associated with a new network. In such case, a previously associated address may have a rules set that will automatically disassociate from the client terminal in step 808. This ensures that prior data that conflicts with current data is removed. Such operations prevent communication from being directed to stale or latent addresses by removing this stale information from the phonebook database. This improves the likelihood of establishing communications through those network pathways in a timely manner.

In summary, the present invention provides a phonebook database operable to support network communications between client terminals. This phonebook database associatively stores client handle, network addressing, and meta-data information. Client terminals may access the phonebook database and retrieve network addressing information and metadata information associated with a client handle. The client terminals are then operable to initiate and manage calls between the client terminals using the network addressing information and metadata associated with the client handle. This metadata may be used to govern or manage calls between client terminals and the selection of network addresses (or communication pathways) to the client terminals.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As one of average skill in the art will appreciate, the term “communicatively coupled”, as may be used herein, includes wireless and wired, direct coupling and indirect coupling via another component, element, circuit, or module. As one of average skill in the art will also appreciate, inferred coupling (i.e., where one element is coupled to another element by inference) includes wireless and wired, direct and indirect coupling between two elements in the same manner as “communicatively coupled”.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. Telephony circuitry of a calling telephony device used by a caller to establish a call session with a recipient, the calling telephony device having a screen and a user input device, the telephony circuitry comprising:
user input interface circuitry communicatively coupled to receive input signals from the user input device;
display interface circuitry communicatively coupled to the screen; communication interface circuitry coupled to a circuit switched telephony network and a packet switched telephony network
the communication interface circuitry supports both a first pathway using a telephone number associated with the circuit switched telephony network, and a second pathway using a routing identifier associated with the packet switched telephony network;
processing circuitry communicatively coupled to the display interface circuitry, the communication interface circuitry, and the user input interface circuitry;
a memory storing a contact association, the contact association comprising the telephone number associated with the first pathway, the routing identifier associated with the second pathway, and a contact handle associated with the recipient; and the processing circuitry responds to a first of the input signals received via the user input interface circuitry by causing the display of the contact association, retrieved from the memory, on the screen through interaction with the display interface circuitry, and the processing circuitry responds to a second of the input signals received via the user input interface circuitry by establishing the call session via a selected one of the first pathway and the second pathway.

2. Telephony circuitry of claim 1, wherein the communication interface circuitry comprises:
a circuit switched telephony communication interface circuitry coupled to the circuit switched telephony network; and
a packet switched telephony communication interface circuitry coupled to the packet switched telephony network.
the communication interface circuitry supports both a first pathway using a telephone number associated with the circuit switched telephony network, and a second pathway using a routing identifier associated with the packet switched telephony network;
a circuit switched telephony interface.

3. Telephony circuitry of claim 1, wherein the circuit switched telephony pathway comprises a circuit switched telephony portion and a packet switched telephony portion.

4. The telephony circuitry of claim 1, wherein the recipient uses a receiving telephony device that supports both the first pathway and the second pathway.

5. The telephony circuitry of claim 1, wherein the recipient uses both a first receiving telephony device that supports the first pathway and a second receiving telephony device that supports the second pathway.

6. The telephony circuitry of claim 1, wherein the contact association further comprising at least one performance indication associated with the second pathway.

7. The telephony circuitry of claim 1, wherein the recipient uses a receiving telephony device having a supplemental media capability, and the contact association further comprising a media identifier corresponding to the supplemental media capability.

8. The telephony circuitry of claim 1, wherein the recipient uses a receiving telephony device having a status, and the contact association further comprising a device status identifier corresponding to the status.

9. The telephony circuitry of claim 1, wherein the recipient has a status, and the contact association further comprising a user status identifier corresponding to the status.

10. The telephony circuitry of claim 1, wherein at least a portion of the contact association stored in the memory was received by the processing circuitry via the second communication interface from a remote storage.

11. Telephony circuitry of a calling telephony device used by a caller to establish a call session with a recipient, the calling telephony device having a screen and a user input device, the telephony circuitry comprising:
user input interface circuitry communicatively coupled to receive input signals from the user input device;
display interface circuitry communicatively coupled to the screen;
communication interface circuitry that supports at least one call pathway, the call pathway having a link availability status and a pathway performance characteristic;
processing circuitry communicatively coupled to the display interface circuitry, the communication interface circuitry, and the user input interface circuitry;
a memory storing a contact association, the contact association comprising both a contact handle associated with the recipient, at least one pathway associated with the recipient, and at least one parameter corresponding to the pathway performance characteristic of the at least one pathway associated with the recipient; and the processing circuitry responds to a first of the input signals received via the user input interface circuitry by causing the display of the contact association, retrieved from the memory, on the screen through interaction with the display interface circuitry, and the processing circuitry responds to a second of the input signals received via the user input interface circuitry by establishing the call session via the at least one pathway call pathway.

12. The telephony circuitry of claim 11, wherein the at least one parameter corresponding to the pathway performance characteristic comprises a link cost parameter associated with the call pathway.

13. The telephony circuitry of claim 11, wherein the contact association further comprises an alternate call pathway with an alternate pathway performance characteristic associated with the contact handle.

14. The telephony circuitry of claim 11, wherein at least a portion of the contact association stored in the memory was received by the processing circuitry via the communication interface circuitry and from a remote storage.

15. The telephony circuitry of claim 11, wherein the contact association, retrieved from the memory and presented on the screen comprises at least one pathway performance characteristic associated with the at least one pathway and at least one pathway performance characteristic associated with the alternative pathway.

16. The telephony circuitry of claim 11, wherein the call session is simultaneously established via the at least one call pathway and the alternative call pathway.

17. The telephony circuitry of claim 11, wherein the call session is sequentially established via the at least one call pathway and the alternative call pathway.

18. Telephony circuitry of a calling telephony device used by a caller to establish a call session with a recipient telephony device, the recipient telephony device supporting communication of voice data and having a supplemental media capability, the calling telephony device having a screen and a user input device, the telephony circuitry comprising:
user input interface circuitry communicatively coupled to receive input signals from the user input device;
display interface circuitry communicatively coupled to the screen;
communication interface circuitry that supports at least one communication pathway to the receiving telephony device;
processing circuitry communicatively coupled to the display interface circuitry, the communication interface circuitry, and the user input interface circuitry;
a memory that associatively stores first data that identifies the recipient telephony device, second data that identifies the at least one communication pathway, and third data that identifies the supplemental media capability; and
the processing circuitry responds to a first of the input signals received via the user input interface circuitry by causing the simultaneous, associated display of the first data, the second data and the third data, retrieved from the memory, on the screen through interaction with the display interface circuitry, and the processing circuitry responds to a second of the input signals received via the user input interface circuitry by establishing the call session via the at least one communication pathway to support the voice data and the supplemental media capability of the recipient telephony device.

19. The telephony circuitry of claim 18, wherein the supplemental media capability comprises:
video playback; and
image playback.

20. The telephony circuitry of claim 18, further comprising supplemental media capture circuitry communicatively coupled to the processing circuitry, the supplemental media capture circuitry to capture supplemental media input signals.

21. The telephony circuitry of claim 18, further comprising supplemental media capture circuitry communicatively coupled to the processing circuitry, the supplemental media capture circuitry to capture supplemental media input signals.

22. The telephony circuitry of claim 18, wherein the at least one communication pathway comprises a first voice pathway and a second supplemental media pathway.

23. The telephony circuitry of claim 18, wherein the at least one communication pathway comprises a circuit switched pathway and a packet switched pathway.

24. The telephony circuitry of claim 18, wherein the recipient telephony device comprises a first recipient device and a second recipient device, and the first recipient device receiving voice data and the second recipient device supporting the supplemental media capability.

25. A method performed by telephony circuitry of a calling telephony device used to establish a call session with a recipient, the calling telephony device having a screen and a user input device, the method comprising:
responding to signals from the user input device by retrieving a telephone number, an Internet identifier, and a recipient identifier that are associatively stored;
delivering the telephone number, the Internet identifier, and the recipient identifier for display on the screen as an association; and
responding to signals from the user input device by establishing the call session using a selected one of the telephone number and the Internet identifier.

26. The method of claim 25, wherein the call session is established using at least one communication pathway associated with the selected one of the telephone number and the Internet identifier.

27. The method of claim 26, the at least one communication pathway comprises a circuit switched telephony portion and a packet switched telephony portion.

28. The method of claim 25, wherein the call session is established to a recipient device associated with the telephone number and the Internet identifier.

29. The method of claim 25, wherein the telephone number and Internet identifier are retrieved from remote storage using the recipient identifier.

30. A method performed by telephony circuitry of a calling telephony device used to establish a call session with a recipient, the calling telephony device having a screen and a user input device, the method comprising:
responding to signals from the user input device by retrieving an association comprising a routing identifier, a recipient identifier, and a pathway performance characteristic;
delivering the association for display on the screen; and
responding to signals from the user input device by establishing the call session using the routing identifier.

31. The method of claim 30, wherein the call session is established using at least one communication pathway associated with the routing identifier.

32. The method of claim 31, the at least one communication pathway comprises a circuit switched telephony portion and a packet switched telephony portion.

33. The method of claim 30, wherein the call session is established using a plurality of communication pathways associated with the routing identifier, wherein a first communication pathway supports a first media capability and a second communication pathway supports a supplemental media capability.

34. The method of claim 30, wherein the association is retrieved from remote storage using the recipient identifier.

35. A method performed by telephony circuitry of a calling telephony device used to establish a call session with a recipient telephony device that has at least one supplemental media capability, the calling telephony device having a screen and a user input device, the method comprising:
responding to signals from the user input device by retrieving an association comprising a routing identifier and a supplemental media indication corresponding to the at least one supplemental media capability;
delivering the association for display on the screen;
responding to signals from the user input device by establishing the call session using the routing identifier; and
using the supplemental media capability of the recipient telephony device during the call session.

36. The method of claim 35, wherein the call session is established using at least one communication pathway associated with the routing identifier.

37. The method of claim 36, the at least one communication pathway comprises a circuit switched telephony portion and a packet switched telephony portion.

38. The method of claim 35, wherein the call session is established using a plurality of communication pathways associated with the routing identifier, wherein a first communication pathway supports a first media capability and a second communication pathway supports the supplemental media capability.
